(19) United States
(12) Patent Application Publication
(10) Pub. No.: US 2003/0206320 A1
(43) Pub. Date: Nov. 6, 2003

(54) Holographic media with a photo-active material for media protection and inhibitor removal

(75) Inventors: Michael C. Cole, Longmont, CO (US); Michael C. Tackitt, Longmont, CO (US)

Correspondence Address: MORRISON & FOERSTER LLP, 1650 TYSONS BOULEVARD, SUITE 300, MCLEAN, VA, 22102, US

(73) Assignee: InPhase Technologies, Inc., Longmont, CO

(21) Appl. No.: 10/411,143

(22) Filed: Apr. 11, 2003

Related U.S. Application Data
(60) Provisional application No. 60/371,406, filed on Apr. 11, 2002.

(51) Int. Cl. G02B 5/32

(52) U.S. Cl. 359/15

(57) ABSTRACT

Holographic media having a photoactive ingredient, such as a photoactive dye, that produces reactive species that directly or indirectly react with oxygen and other inhibitors present in the media to protect the media before recording are disclosed. Methods for holographic media protection and inhibitor and oxygen removal are also disclosed.

### RELATED APPLICATION

This application claims priority from U.S. Provisional Application No. 60/371,406, filed Apr. 11, 2002, which is entitled “A METHOD FOR MEDIA PROTECTION, OXYGEN INHIBITION REDUCTION AND REAL TIME MEASUREMENT OF PRE-EXPOSURE BY A PHOTOBLEACHABLE INGREDIENT.”

### Field of the Invention

The invention relates to optical articles including holographic recording media, in particular media useful either with holographic storage systems or as components such as optical filters or beam steerers. In particular, the media contains a photoactive ingredient that produces reactive species that directly or indirectly react with oxygen and other inhibitors that protect the media before recording. Also disclosed, media containing a photobleachable film or layer that behaves as a spatial filter as well as a method of measuring the dynamic range or readiness of the media for writing.

### BACKGROUND

Developers of information storage devices and methods continue to seek increased storage capacity. As part of this development, so-called page-wise memory systems, in particular, a holographic system, have been suggested as alternatives to conventional memory devices.

A hologram stores data in three dimensions and reads an entire page of data at one time, i.e., page-wise, which is unlike an optical CD disk that stores data in two dimensions and reads a bit at a time. Page-wise systems involve the storage and readout of an entire two-dimensional representation, e.g., a page of data. Typically, recording light passes through a two-dimensional array of dark and transparent areas representing data, and the holographic system stores, in three dimensions, holographic representations of the pages as patterns of varying refractive index imprinted into a storage medium. Holographic systems are discussed generally in D. Psaltis et al., “Holographic Memories,” Scientific American, November 1995, the disclosure of which is hereby incorporated by reference. One method of holographic storage is phase correlation multiplex holography, which is described in U.S. Pat. No. 5,719,691 issued Feb. 17, 1998, the disclosure of which is hereby incorporated by reference.

A hologram is a pattern, also known as a grating, which is formed when two laser beams interfere with each other in a light-sensitive material (LSM) whose optical properties are altered by the intersecting beams. One choice of a LSM is a photosensitive polymer film.

The advantages of recording a hologram are high density (storage of hundreds of billions of bytes of data), high speed (transfer rate of a billion or more bits per second) and ability to select a randomly chosen data element in 100 microseconds or less. These advantages arise from three-dimensional recording and from simultaneous readout of an entire page of data at one time.

Holographic media that utilizes photopolymerization, however, experiences three inherent phenomena that limit their performance: dynamic range reduction via stray light, polymerization inhibition (from oxygen and other inhibitors), and overexposure of light just prior to recording. In general, an optimized holographic material should be highly photoreactive with little to zero induction time before recording of data begins. However, such highly sensitive materials are prone to loss of recording capacity when stray light from laser reflections, room light, and/or any other light source interacts with areas of the media before recording in that area has been performed.

Currently, a small percentage of inhibitors and oxygen are present in the media formulations to prevent loss of recordability before recording has been performed and also function to stabilize the media for long-term storage. Only small amounts of such inhibitors can be used as large amounts prevent efficient recording of data. Large amounts of inhibitor both slow down the over all polymerization rate (recording rate) and create a longer inhibition period (the period in which photoinitiation is occurring but no polymer is forming because of chain transfer/termination reactions with inhibitors). However, small percentages of inhibitors do not adequately protect the media from stray reflections during recording or during an accidental exposure to other light sources. Thus, the small amount of inhibitor is just enough to thermally stabilize the media for long term storage and to be quickly consumed when the writing process begins, so stray light eliminates the inhibitors too soon (before the actual writing process). However, small percentages of inhibitors do not adequately protect the media from stray reflections during recording or during an accidental exposure to other light sources.

To date, pre-exposures are typically performed to remove inhibitors in the media prior to recording data by using light of the same wavelength as is used to write the diffraction grating, thus providing the possibility of over exposure. A pre-exposure step is necessary to overcome oxygen inhibition, added inhibitors (i.e., phenols), and other inhibitory agents. To date, pre-exposures are typically done using light of the same wavelength that is used to write the diffraction grating thus providing the possibility of over exposure.

Over exposure decreases the dynamic range of the sample by decreasing the concentration of both the photoinitiator and write monomer. Therefore, there exists a need to remove inhibitors in the media without degradation of the dynamic range.

### SUMMARY OF THE INVENTION

This invention in high performance holographic recording articles is based on the use of appropriate photoactive dyes (or dye systems) as a method for media protection, inhibitor removal, and gaugable, i.e., pre-determinable and/or measurable, pre-exposure. Additionally, other sources of radicals other than dyes and dye systems are exploited for use as inhibitor scavengers. Of particular interest, thiazine derivatives in combination with an activator (borate salt, amine, thiourea, etc.) were found to work well as a pre-exposure step and media protector. While dye with activator systems are used to initiate free radical polymerization using long wavelength absorbing dyes (example dyes include Rose Bengal and Methylene Blue), Applicants found that it is possible to use these radical generating systems as a pre-exposure step to insure that over-exposure of sample does not occur.

Also, the dye/dye system does not need an activating donor. For instance, methylene blue is a singlet O₂ sensitizer. As such, the methylene blue without donors can be irradiated to produce singlet O₂ that will then react with vinyl groups and others to form peroxides and other oxidized products. Methylene blue (or other dye) will not bleach in this scenario (nor does it need to depending on the writing wavelength), yet it will remove the inhibitory agents all the same. A second example for using dye compounds without an activator is with the use of thione compounds (i.e. thiobenzophenone). These compounds are known to photooxidize (thus react with oxygen directly in the excited state—thiobenzophenone→benzophenone). With this latter example, the thione compound loses its long wavelength absorbtion (photobleaches in the presence of O₂).

In addition, more than one dye can be used at one time for the purpose of covering a larger area of the spectrum. Such dye combinations can have one component that absorbs at essentially the same wavelengths as the recording laser (for green wavelengths—fluorone derivatives can be used) and a second component that absorbs far into the red (example—methylene blue). In such a combination it was found that excitation of methylene blue bleached both the methylene blue and the fluorone derivatives whereas irradiation of the fluorone derivative alone did not initiate polymerization until almost all of both dyes were bleached—the inhibition time is actually increased in such a case relative to the case without the dyes because Methylene Blue and many other dyes are inhibitors to free radical polymerization and thus their presence actually increases the concentration of the inhibitory agents, thus providing more protection to the system yet with easy removal.

As will be realized, this invention is capable of other and different embodiments, and its details are capable of modifications in various obvious respects, all without departing from this invention. Accordingly, the drawings and descriptions are to be regarded as illustrative in nature and not as restrictive.

### BRIEF DESCRIPTION OF THE DRAWINGS

FIG. 1 is an example of the setup used in the experiments with a blue 410 nm laser diode for writing and a 440 nm diode for indicator stimulation.

### DETAILED DESCRIPTION OF THE INVENTION

An embodiment of this invention is an optical article comprising a photoactive material that records a hologram upon exposure of the photoactive material to a first wavelength of light, a reaction inhibitor that inhibits a reaction of said photoactive material and a photoactive ingredient that reacts with said reaction inhibitor upon exposure of said photoactive ingredient to a second wavelength of light, wherein the second wavelength is different from the first wavelength and the photoactive material records substantially no hologram at the second wavelength.

A “photoactive material” represents compounds or mixtures of compounds that are capable of forming a spatially defined difference in refraction within a matrix material upon exposure to IR, Visible, and/or UV light and typically, though not limited to, include monomer and recording initiator (independently or in combination thereof). A “photoactive material” includes monomer and recording initiator (independently or in combination thereof). Monomer is to be understood as any molecule capable of forming a polymer. A few examples of monomers are acrylates, vinyl ethers, styrene derivatives, vinyl amides, vinyl esters, epoxides, thiol-ene systems, bisanthracenes, or combinations thereof.

A “reaction inhibitor” represents compounds or mixtures that prevent sustained reactions that consume photoactive material. Such compounds typically, though not limited to, include oxygen and added inhibitors (free radical and ionic), independently or in combination thereof. A “reaction inhibitor” includes oxygen, added inhibitors, and sometimes the dye, independently or in combination thereof.

A “photoactive ingredient” represents compounds or mixtures of compounds that preferentially deactivate Reaction Inhibitors upon excitation with light and typically, though not limited to, include dyes, combinations of dyes, and donor molecules (to reduce the dyes) either in combinations with one another or independently with the exception of the donor molecules as they are never with out a dye though a dye can be with out a donor. A second inclusion for a Photoactive ingredient includes compounds or mixtures of compounds that have the ability to determine the relative concentration of Reaction Inhibitors in the system and typically, though not limited to, include fluoromore indicators.

A “photoactive ingredient” includes indicators, dyes, combinations of dyes, and activator molecules either in combinations with one another or independent with the exception of the donor molecules as they are never with out a dye, though a dye can be without a donor. Further description of terms, a donor is considered as a subset of activator and for the most part can be used interchangeably. The distinction between the two being that a donor is always oxidized by the excited chromophore, whereas an activator may be oxidized or reduced during its interaction with the excited chromophore.

Preferably, the amounts (based on the composition of the optical article) are as follows: photoactive material is 1 wt % to 30 wt %, reaction inhibitor—1 ppm to 2000 ppm, photoactive ingredient—0.01 wt % to 5 wt %, if dye and donor are used together then the molar ratio between the two should be 1:1 to 1:10 (dye:donor) preferred. The molar relationship between the photoactive ingredient and the reaction inhibitors should be in the range of 1:0.1 to 1:5.

More preferred: photoactive material—1 wt % to 10 wt %, reaction inhibitor—1 ppm to 1000 ppm, photoactive ingredient—0.01 wt % to 2 wt %, if dye and donor are used together then the molar ratio between the two should be 1:5 to 1:10 (dye:donor) more preferred. The molar relationship between the photoactive ingredient and the reaction inhibitors should be in the range of 1:0.5 to 1:2.

Most preferred: photoactive material—3 wt % to 10 wt %, reaction inhibitor—1 ppm to 500 ppm, photoactive ingredient—0.01 wt % to 1 wt %, if dye and donor are used together then the molar ratio between the two should be 1:10 (dye:donor) most preferred. The molar relationship between the photoactive ingredient and the reaction inhibitors should be in the range of 1:0.9 to 1:1.1. It is understood that if shrinkage is not as much of an issue for a particular embodiment (i.e. display holograms and HOE devices), then the most preferred amounts would include a larger amount of photoactive material and thus becomes similar to the preferred ranges.

The optical article further comprises a photoinitiator that initiates the reaction of the photoactive material. The amount of the photoinitiator material could be 0.1 wt % to 10 wt % (preferred), 0.5 wt % to 8 wt % (more preferred), or 2 wt % to 5 wt % (most preferred) of the composition of the optical article.

The optical article further comprises oxygen and a material that upon excitation with light either directly or indirectly eliminates free oxygen from the system before recording. The concentration of the material to be dependent on the concentration of oxygen and other inhibitors in the system and should be formulated such that total reaction of the material eliminates between 90% to 100% of the inhibitors and yet does not reduce the dynamic range of the media by more than 5% (as compared to without the use of the material).

More Preferred: The concentration of the material to be dependent on the concentration of oxygen and other inhibitors in the system and should be formulated such that total reaction of the material eliminates between 93% to 100% of the inhibitors and yet does not reduce the dynamic range of the media by more than 2% (as compared to without the use of the material).

Most preferred: The concentration of the material to be dependent on the concentration of oxygen and other inhibitors in the system and should be formulated such that total reaction of the material eliminates between 98% to 100% of the inhibitors and yet does not reduce the dynamic range of the media by more than 0% (as compared to without the use of the material).

Photoactive dyes are chemicals that upon absorption of light produce reactive species (such as a radical, a cation, an anion, an oxidizer, a reducer, an excited molecule, or a ground state molecule) that directly or indirectly reacts with oxygen and other inhibitory agents. Photoactive dye systems are multiple component systems, which perform the same function of reacting with oxygen and other inhibitors. Dyes and dye systems are those which upon exposure to electromagnetic radiation (ultra-violet, visible, and infrared) will photobleach and produce reactive species such as radicals, cations, anions, etc. It is also recognized that the dye does not need to bleach in all embodiments, for example, if the dye and the dye photoproducts do not absorb at the writing wavelength, then bleaching of the dye is not necessary.

Holographic recording media is to be understood as a matrix, typically, a polymeric matrix, which includes a photoactive material, preferably a photoactive monomer, an inhibitor, and optionally an initiator and does not refer to the substrates, coatings, and packaging that house the recording media.

The optical article, e.g., holographic recording medium, of the invention is formed by steps including mixing a matrix precursor and a photoactive material, preferably a photoactive monomer, and curing the mixture to form the matrix in situ. Preferably, the matrix precursor and photoactive monomer are selected such that (a) the reaction by which the matrix precursor is polymerized during the cure is independent from the reaction by which the photoactive monomer will be polymerized during writing of a pattern, e.g., diffraction gratings (though it is recognized that matrix formation and grating writing can be of the same mechanism as in U.S. Pat. No. 5,874,187), and (b) the matrix polymer and the polymer resulting from polymerization of the photoactive monomer (the photopolymer) are compatible with each other. As discussed previously, the matrix is considered to be formed when the photorecording material, i.e., the matrix material plus the photoactive monomer, photoinitiator, and/or other additives, exhibits an ability to form holograms and keep them for months without significant deterioration.

The compatibility of the matrix polymer and photopolymer tends to prevent large-scale (>100 nm) phase separation of the components, such large-scale phase separation typically leading to undesirable haziness or opacity. Utilization of a photoactive monomer and a matrix precursor that polymerize by independent reactions provides a cured matrix substantially free of cross-reaction, i.e., the photoactive monomer remains substantially inert during the matrix cure. In addition, due to the independent reactions, there is no inhibition of subsequent polymerization of the photoactive monomer except for oxygen or other added inhibitors. The resulting optical article is capable of exhibiting desirable refractive index contrast due to the independence of the matrix from the photoactive monomer.

The optical article is capable of exhibiting desirable refractive index contrast due to the independence of the matrix from the photoactive monomer. As discussed above, formation of a hologram, waveguide, or other optical article relies on a refractive index contrast (An) between exposed and unexposed regions of a medium, this contrast is at least partly due to monomer diffusion to exposed regions. High index contrast is desired because it provides improved signal strength when reading a hologram, and provides efficient confinement of an optical wave in a waveguide. One way to provide high index contrast in the invention is to use a photoactive monomer having moieties (referred to as index-contrasting moieties) that are substantially absent from the matrix, and that exhibit a refractive index substantially different from the index exhibited by the bulk of the matrix. For example, high contrast would be obtained by using a matrix that contains primarily aliphatic or saturated alicyclic moieties with a low concentration of heavy atoms and conjugated double bonds (providing low index) and a photoactive monomer made up primarily of aromatic or similar high-index moieties.

The matrix is a polymeric network formed in situ from a precursor by a curing step (curing indicating a step of inducing reaction of the precursor to form the polymeric matrix). It is possible for the precursor to be one or more monomers, one or more oligomers, or a mixture of monomer and oligomer. In addition, it is possible for there to be greater than one type of precursor functional group, either on a single precursor molecule or in a group of precursor molecules. (Precursor functional groups are the group or groups on a precursor molecule that are the reaction sites for polymerization during matrix cure.) To promote mixing with the photoactive monomer, the precursor is advantageously liquid at some temperature between about −50° C. and about 80° C. Advantageously, the matrix polymerization is capable of being performed at room temperature. Also advantageously, the polymerization is capable of being performed in a time period less than 5 minutes. The glass transition temperature (T_{g}) of the photorecording material is advantageously low enough to permit sufficient diffusion and chemical reaction of the photoactive monomer during a holographic recording process. Generally, the T_{g} is not more than 50° C. above the temperature at which holographic recording is performed, which, for typical holographic recording, means a T_{g} between about 80° C. and about −130° C. (as measured by conventional methods). It is also advantageous for the matrix to exhibit a three-dimensional network structure, as opposed to a linear structure, to provide the desired modulus discussed previously.

Examples of polymerization reactions contemplated for forming matrix polymers in the invention include cationic epoxy polymerization, cationic vinyl ether polymerization, cationic alkenyl ether polymerization, cationic allene ether polymerization, cationic ketene acetal polymerization, epoxy-amine step polymerization, epoxy-mercaptan step polymerization, unsaturated ester-amine step polymerization (via Michael addition), unsaturated ester-mercaptan step polymerization (via Michael addition), vinyl-silicon hydride step polymerization (hydrosilylation), isocyanate-hydroxyl step polymerization (urethane formation), sol-gel reactions, cyanoacrylate anionic polymerization, and isocyanatae-amine step polymerization (urea formation). Even radical chain reactions such as acrylate (or other vinyl monomer/oligomer) radical polymerizations can be used with proper formulation.

Several such reactions are enabled or accelerated by suitable catalysts. For example, cationic epoxy polymerization takes place rapidly at room temperature by use of BF₃-based catalysts (or other Lewis acids), other cationic polymerization processes proceed in the presence of protons, epoxy-mercaptan reactions and Michael additions are accelerated by bases such as amines, hydrosilylation proceeds rapidly in the presence of transition metal catalysts such as platinum, and urethane and urea formation proceed rapidly when tin catalysts are employed. It is also possible to use photogenerated catalysts for matrix formation, provided that steps are taken to prevent polymerization of the photoactive monomer during the photogeneration.

A typical holographic recording article composition comprises the following ingredients:

| | | |
|---|---|---|
| Polyisocyanates | 20-50 | Wt % |
| Acrylate Monomers | 1-15 | Wt % |
| Photoinitiators | 0.1-5 | Wt % |
| Polyols | 40-80 | Wt % |
| Catalysts | 0.1-3 | Wt % |
| Additives | 0.001-0.5 | Wt % |
| Dye and dye systems | 0.001-0.5 | Wt % |

Polyisocyanates are aliphatic or cycloaliphatic with two and higher functionality. Examples are hexamethylene diisocyanate (HDI), trimethylhexamethyle diisocyanates (TMDI), isophorone diisocyanate (IPDI), bis(4-isocyanatocyclohexyl)methane (HMDI), and tetramethylxylylene diisocyanate (TMXDI). Optionally oligomers with NCO-terminated functionality can also be used. Preferred polyisocyanates are hexamethylene diisocyanate (HDI) and its biuret, uretidione, and isocyanuate derivatives.

The NCO-terminated prepolymers are selected from the by-products of diols and diisocyanates that have wt % contents of NCO in the range of 10 to 25. The NCO contents were determined based on the prepolymer, unreacted diisocyanate and optionally added neat polyisocyanates to achieve the high performance characteristics. Aromatic diisocynates based prepolymers could also be used.

Polyols are selected from diols and triols of polytetramethylene glycol, polycaprolactone, polypropylene oxide and other polyether and polyester polyols. Preferred polyols are polypropylene oxide triols with molecular weight ranging from 450 to 6,000 and polytetramethylene glycol with molecular weight from 600 to 3,000. Preferably, the polyols are free of moisture contents for the initial reaction with the excess amount of polyisocyanates to assure bubble-free matrix systems are formed. High temperature vacuum distillation treatments or additives such as moisture scavengers or catalysts which only promote reaction of isocynates to hydroxyl other than water may be used to assure no water residue remains in the polyols before use, or if it is present, it does not interfere with matrix formation.

A photoactive material could be any material, preferably a photoactive monomer, capable of undergoing a reaction, preferably photoinitiated polymerization, by exposure to light. Furthermore, if the photoactive material is a photoactive monomer, then the photoactive monomer, in combination with matrix materials, meets the polymerization reaction and compatibility requirements of the invention.

Suitable photoactive monomers include those which polymerize by a free-radical reaction, e.g., molecules containing ethylenic unsaturation such as acrylates, methacrylates, acrylamides, methacrylamides, styrene, substituted styrenes, vinyl naphthalene, substituted vinyl naphthalenes, and other vinyl derivatives. The preferred acrylate monomers are monofunctional. These include 2,4,6-tribromophenylacrylate, pentabromoacrylate, isobornylacrylate, phenylthioethyl acrylate tetrahydrofurfurylacrylate, 1-vinyl-2-pyrrolidinone, asymmetric bis thionapthyl acrylate, 2-phenoxyethylacrylate, and the like.

A free-radical copolymerizable pair system, such as vinyl ether mixed with maleate and thiol mixed with olefin, is also suitable. It is also possible to use cationically polymerizable systems such as vinyl ethers, alkenyl ethers, allene ethers, ketene acetals, and epoxies. It is also possible for a single photoactive monomer molecule to contain more than one monomer functional group. As mentioned previously, relatively high index contrast is desired in the article of the invention, whether for improved readout in a recording media or efficient light confinement in a waveguide. In addition, it is advantageous to induce this relatively large index change with a small number of monomer functional groups, because polymerization of the monomer generally induces shrinkage in a material.

Shrinkage has a detrimental effect on the retrieval of data from stored holograms, and also degrades the performance of waveguide devices such as by increased transmission losses or other performance deviations. Lowering the number of monomer functional groups that must be polymerized to attain the necessary index contrast is therefore desirable. This lowering is possible by increasing the ratio of the molecular volume of the monomers to the number of monomer functional groups on the monomers. This increase is attainable by incorporating into a monomer larger index-contrasting moieties and/or a larger number of index-contrasting moieties. For example, if the matrix is composed primarily of aliphatic or other low index moieties and the monomer is a higher index species where the higher index is imparted by a benzene ring, the molecular volume could be increased relative to the number of monomer functional groups by incorporating a naphthalene ring instead of a benzene ring (the naphthalene having a larger volume), or by incorporating one or more additional benzene rings, without increasing the number of monomer functional groups. In this manner, polymerization of a given volume fraction of the monomers with the larger molecular volume/monomer functional group ratio would require polymerization of less monomer functional groups, thereby inducing less shrinkage. But the requisite volume fraction of monomer would still diffuse from the unexposed region to the exposed region, thus providing the desired refractive index.

The molecular volume of the monomer, however, should not be so large as to slow diffusion below an acceptable rate. Diffusion rates are controlled by factors including size of diffusing species, Tg of the matrix, cross-link density, viscosity of the medium, and intermolecular interactions. Larger species tend to diffuse more slowly, but it would be possible in some situations to lower the viscosity or make adjustments to the other molecules present in order to raise diffusion to an acceptable level. Also, in accord with the discussion herein, it is important to ensure that larger molecules maintain compatibility with the matrix.

Numerous architectures are possible for monomers containing multiple index-contrasting moieties. For example, it is possible for the moieties to be in the main chain of a linear oligomer, or to be substituents along an oligomer chain. Alternatively, it is possible for the index-contrasting moieties to be the subunits of a branched or dendritic low molecular weight polymer.

In addition to the photoactive monomer, the optical article typically contains a photoinitiator (the photoinitiator and photoactive monomer being part of the overall photoimageable system). The photoinitiator, upon exposure to relatively low levels of the recording light, chemically initiates the polymerization of the monomer, avoiding the need for direct light-induced polymerization of the monomer. The photoinitiator generally should offer a source of species that initiate polymerization of the particular photoactive monomer. Typically, 0.01 to 20 wt. % photoinitiator, based on the weight of the photoimageable system, provides desirable results.

A variety of photoinitiators known to those skilled in the art and available commercially are suitable for use in the invention. Photoinitiators are selected according to their sensitivity to the light sources. For example, Irgacure 369, Irgacure 819, ITX, and Irgacure 907 are suitable for commercial blue laser systems. CGI-784 is suitable for green laser systems, and CB-650 is suitable for red laser systems. Irgacure and CGI are available from Ciba, CB-650 from Spectra Group. CGI-784 is bis(η-5-2,4-cyclopentadien-1-yl)bis[2,6-difluoro-3-(1H-pyrrol-1-yl)phenyl]titanium.

The photoinitiating systems of this invention could further comprise UV initiators from Ciba Specialty Chemicals (CSC) that have absorption maxima at UV wavelengths and absorption tails that stretch into the blue region of the electromagnetic spectrum between 400 and 500 nm. These include Darocur® 4265, Irgacure® 184, Irgacure® 369, Irgacure® 1800, Irgacure® 2020, and Irgacure® 819, with the last being preferred. Some of the photoinitiators available from CSC that could be used in this invention have the following properties.

Irgacure® 819 is a phosphine oxide photoinitiator in which the absorption is from 440 nm (visible blue) and lower in the UV spectrum.

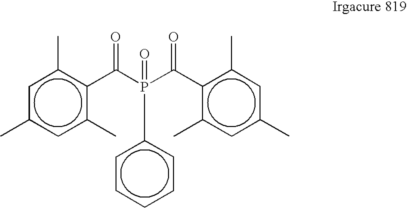

Irgacure® 819XF is a finely ground version of Irgacure® 819 which dissolves much more rapidly in common acrylate monomers.

Irgacure® 2020 is a liquid phosphine oxide containing photoinitiator.

Irgacure® 1300 is a fast dissolving alpha-hydroxy ketone based photo initiator with improved solubility as compared to Irgacure® 369.

Irgacure® 184 is a non-yellowing solid photoinitiator useful as a co-initiator in many formulations.

Darocur® 1173 is a non-yellowing liquid photoinitiator with low viscosity. Good solvency properties make it useful in blends with other photoinitiators.

Irgacure® 500 is a liquid blend of benzophenone and Irgacure® 184. Due to the inclusion of benzophenone in this eutectic mixture, the formulation should contain an extractable hydrogen-donating component to achieve optimal performance.

Irgacure® 651 is a general-purpose solid UV photoinitiator useful in formulations containing styrene and where post yellowing is not a concern.

Darocur® 4265 is a liquid photoinitiator comprising a blend of Darocur® 1173 and Lucirin® TPO. Lucirin® TPO is a product of BASF.

Irgacure® 2959 is a very low odor and low volatility photoinitiator. It contains a terminal OH group, which may provide a site for additional reactions.

Other photoinitiators from CSC include Irgacure® 369, Irgacure® 1800 and Irgacure® 1700.

The above photo initiators could be used alone or in combination with another initiator.

Also, diphenyl (2,4,6-trimethylbenzoyl)phosphine oxide [DTBPO], which is not from CSC but can be obtained from Aldrich could be used as a photoinitiator. This is a phosphine oxide similar to Irgacure® 819, but having lower absorbance in the blue region of the spectrum. The formula of DTBPO is the following:

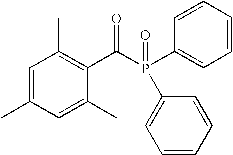

Preferably, tin catalysts are used for setting up the matrix. These are dialkyltinlaurates, dialkyltindilaurates, stannous octoate, dialkyltin carboxylates, dialkyltin mercaptides, mercury-based tin compounds, and others.

Other additives include thermal stabilizers such as butyrated hydroxytoluene (BHT), phenothiazine, hydroquinone, and methylether of hydroquinone; oxidizers such as peroxides, phosphites, and hydroxyamines; and deformers or deaerators to eliminate entrapped air bubbles.

The dyes and dye systems include acetophenone derivatives, aromatic ketone derivatives, and typical photoreducible dyes (and their derivatives) such as rose bengal, fluorescein, methylene blue and others. For some dyes, additional activating components are often added such as amines, borate salts or other donor molecules for the purpose of reducing the dye upon its excitation with light. In all these examples, the dye molecule absorbs light and produces reactive species capable of reacting with oxygen and other inhibitors. When used as a method for removal of inhibitors such dyes would be added in small concentrations that roughly approximate the concentration of inhibitory agents. Then, upon exposure to a wavelength of light different from the wavelength used to record diffraction gratings and ideally at a wavelength at which the photoinitiator used for recording does not absorb, the dye will be bleached (with regard to the writing wavelength if the dye absorbs there) and produce a specific number of reactive species. Overexposure is not possible since the small concentration of dye is not efficient at initiating monomer polymerization (due to the inhibitors that react with the produced reactive species) and since the wavelength used is not able to excite the photoinitiator used for recording diffraction gratings. The bleaching of the dye can be followed by a light detector, thus providing a method for determining when recording can begin.

In the current holographic writing setup, a red servo laser is used to track positions on the holographic media. The servo laser thus serves as a second wavelength different from the writing wavelength that can be used to prepare the sample for writing. In such a scenario, the dye (and subsequent concentration) is chosen such that the servo laser has 60-90% transparency (this allows the servo laser to track its position on the media). Then when the servo laser has acquired the proper position for the write step, a lens or beam expander is placed in front of the servo laser to make the spot size of the servo laser the same as the spot size for the writing laser. As the beam bleaches the dye/dye system the servo laser detector records the bleaching progress and can thus determine when bleaching is complete. The normal writing process then begins. In summary, the servo laser and servo detector are used to determine when bleaching has been completed.

Additionally, servoing can be done via transmission or reflective methods. If transmissive is being used then the above description is adequate. If a reflective method is being used then it no longer is a requirement that the servo laser have some transmission through the sample. This later scenario would be considered as the ideal scenario, since the dye or dye system can be chosen to absorb maximally at the servo wavelength (this greatly speeds the pre-exposure step since bleaching of the dye is faster). The progress of the bleaching is followed by the servo detector (as with the transmissive method), though a mirror is place on the opposite side of the servo laser to reflect the beam back through the media so that it can be directed to the servo detector.

An indicator can also be used to measure the dynamic range of the media if the indicator is also a polymerizable monomer or some other molecule that loses its ability to fluoresce during polymerization. For instance, certain monomers are known to fluoresce or phosphoresce until polymerized. And still, other monomers and molecules are known to fluoresce in the absence of O₂ but not in the presence of O₂. Thus it remains a possibility that an indicator can be used both for inhibitor concentration measuring or dynamic range measuring and even potentially both.

It is possible to use both the indicator and the dye in combination to provide a method for both protecting the media from stray light and for removal of inhibitors. In such an application excess dye can be used (in excess of inhibitors). The indicator would simply provide information concerning removal of the inhibitors and thus signal when recording can proceed independent of the concentration of the dye. In this application the dye or dye system would absorb a broad range of wavelengths including the wavelengths used for recording. Since the dye would ideally absorb at the same wavelength as the photoinitiator used for recording, excess dye remaining after removal of inhibitors will then be used to initiate polymerization in tandem with the photoinitiator used for recording. In one embodiment, the chosen dye is capable of initiating polymerization of the monomer, which is not necessarily implied when the dye is used solely to react with inhibitors or protect the media from stray light.

As a protective element (performing as a temporary light block) for the media against stray light, the dye or dye system need not be a component of the recording media and thus may be a layer on the substrate containing the recording media. For example, the photobleaching film (containing the dye or dye system) may be a component layer of an antireflective coating or a film layer between the substrate and media. Of course, in these locations, the dye or dye system functions only as a method to protect the media from stray light (and does not give the benefits describe above for reduction of inhibitors). Independent of location, the photobleaching dye or dye system ideally absorbs light over a broad section of the visible spectrum specifically including the wavelengths absorbed by the photoinitiator used for recording. Furthermore, the light protective element performs as a spatial filter during the recording process, which prevents 2^{nd} and third order beams from consuming initiator and monomer in the area surrounding the recording area. The ability to perform as a spatial filter increases the packing density of data since previous recording without a spatial filter would lead to partial consumption of monomer and photoinitiator in areas directly adjacent to the recording area. The current holographic drive setup uses an external spatial filter (external to the media); and thus, use of an internal chemical spatial filter in the media simplifies the overall system design by reducing the number of necessary components.

For purposes of the invention, polymers are considered to be compatible if a blend of the polymers is characterized, in 90° light scattering, by a Rayleigh ratio (R_{90°}) less than 7×10⁻³ cm⁻¹. The Rayleigh ratio, R_{θ}, is a conventionally known property, and is defined as the energy scattered by a unit volume in the direction θ, per steradian, when a medium is illuminated with a unit intensity of unpolarized light, as discussed in M. Kerker, The Scattering of Light and Other Electromagnetic Radiation, Academic Press, San Diego, 1969. The light source used for the measurement is generally a laser having a wavelength in the visible part of the spectrum. Normally, the wavelength intended for use in writing holograms is used. The scattering measurements are made upon a photorecording material that has been flood exposed. The scattered light is collected at an angle of 90° from the incident light, typically by a photodetector. It is possible to place a narrowband filter, centered at the laser wavelength, in front of such a photodetector to block fluorescent light, although such a step is not required. The Rayleigh ratio is typically obtained by comparison to the energy scatter of a reference material having a known Rayleigh ratio.

Polymer blends that are considered to be miscible, e.g., according to conventional tests such as exhibition of a single glass transition temperature, will typically be compatible as well, i.e., miscibility is a subset of compatibility. Standard miscibility guidelines and tables are therefrom useful in selecting a compatible blend. However, it is possible for polymer blends that are immiscible to be compatible according to the light scattering test above.

A polymer blend is generally considered to be miscible if the blend exhibits a single glass transition temperature, T_{g}, as measured by conventional methods. An immiscible blend will typically exhibit two glass transition temperatures corresponding to the T_{g} values of the individual polymers. T_{g} testing is most commonly performed by differential scanning calorimetry (DSC), which shows the T_{g} as a step change in the heat flow (typically the ordinate). The reported T_{g} is typically the temperature at which the ordinate reaches the mid-point between extrapolated baselines before and after the transition. It is also possible to use Dynamic Mechanical Analysis (DMA) to measure T_{g}. DMA measures the storage modulus of a material, which drops several orders of magnitude in the glass transition region. It is possible in certain cases for the polymers of a blend to have individual T_{g} values that are close to each other. In such cases, conventional methods for resolving such overlapping T_{g} should be used, such as discussed in Brinke et al., “The thermal characterization of multi-component systems by enthalpy relaxation,” Thermochimica Acta., 238 (1994), at 75.

Matrix polymer and photopolymer that exhibit miscibility are capable of being selected in several ways. For example, several published compilations of miscible polymers are available, such as O. Olabisi et al, Polymer-Polymer Miscibility, Academic Press, New York, 1979; L. M. Robeson, MMI, Press Symp. Ser., 2, 177, 1982; L. A. Utracki, Polymer Alloys and Blends: Thermodynamics and Rheology, Hanser Publishers, Munich, 1989; and S. Krause in Polymer Handbook, J. Brandrup and E. H. Immergut, Eds., 3rd Ed., Wiley Interscience, New York, 1989, pp. VI 347-370, the disclosures of which are hereby incorporated by reference. Even if a particular polymer of interest is not found in such references, the approach specified allows determination of a compatible photorecording material by employing a control sample.

Determination of miscible or compatible blends is further aided by intermolecular interaction considerations that typically drive miscibility. For example, it is well known that polystyrene and poly(methylvinylether) are miscible because of an attractive interaction between the methyl ether group and the phenyl ring. It is therefore possible to promote miscibility, or at least compatibility, of two polymers by using a methyl ether group in one polymer and a phenyl group in the other polymer. It has also been demonstrated that immiscible polymers are capable of being made miscible by the incorporation of appropriate functional groups that can provide ionic interactions. (See Z. L. Zhou and A. Eisenberg, J. Polym. Sci., Polym. Phys. Ed., 21 (4), 595, 1983; R. Murali and A. Eisenberg, J. Polym. Sci., Part B: Polym. Phys., 26 (7), 1385, 1988; and A Natansohn et al., Makromol. Chem., Macromol. Symp., 16, 175, 1988). For example polyisoprene and polystyrene are immiscible. However, when polyisoprene is partially sulfonated (5%), and 4-vinyl pyridine is copolymerized with the polystyrene, the blend of these two functionalized polymers is miscible. It is contemplated that the ionic interaction between the sulfonated groups and the pyridine group (proton transfer) is the driving force that makes this blend miscible. Similarly, polystyrene and poly(ethyl acrylate), which are normally immiscible, have been made miscible by lightly sulfonating the polystyrene. (See R. E. Taylor-Smith and R. A. Register, Macromolecules, 26, 2802, 1993.) Charge-transfer has also been used to make miscible polymers that are otherwise immiscible. For example it has been demonstrated that, although poly(methyl acrylate) and poly(methyl methacrylate) are immiscible, blends in which the former is copolymerized with (N-ethylcarbazol-3-yl)methyl acrylate (electron donor) and the latter is copolymerized with 2-[(3,5-dinitrobenzoyl)oxy]ethyl methacrylate (electron acceptor) are miscible, provided the right amounts of donor and acceptor are used. (See M. C. Piton and A. Natansohn, Macromolecules, 28, 15, 1995.) Poly(methyl methacrylate) and polystyrene are also capable of being made miscible using the corresponding donor-acceptor co-monomers (See M. C. Piton and A. Natansohn, Macromolecules, 28, 1605, 1995).

A variety of test methods exist for evaluating the miscibility or compatibility of polymers, as reflected in the recent overview published in A. Hale and H. Bair, Ch. 4—“Polymer Blends and Block Copolymers,” Thermal Characterization of Polymeric Materials, 2nd Ed., Academic Press, 1997. For example, in the realm of optical methods, opacity typically indicates a two-phase material, whereas clarity generally indicates a compatible system. Other methods for evaluating miscibility include neutron scattering, infrared spectroscopy (IR), nuclear magnetic resonance (NMR), x-ray scattering and diffraction, fluorescence, Brillouin scattering, melt titration, calorimetry, and chemilluminescence. See, for example, L. Robeson, supra; S. Krause, Chemtracts—Macromol. Chem., 2, 367, 1991a; D. Vessely in Polymer Blends and Alloys, M. J. Folkes and P. S. Hope, Eds., Blackie Academic and Professional, Glasgow, pp. 103-125; M. M. Coleman et al. Specific Interactions and the Miscibility of Polymer Blends, Technomic Publishing, Lancaster, Pa., 1991; A. Garton, Infrared Spectroscopy of Polymer Blends, Composites and Surfaces, Hanser, N. Y., 1992; L. W. Kelts et al., Macromolecules, 26, 2941, 1993; and J. L. White and P. A. Mirau, Macromolecules, 26, 3049, 1993; J. L. White and P. A. Mirau, Macromolecules, 27, 1648, 1994; and C. A. Cruz et al., Macromolecules, 12, 726, 1979; and C. J. Landry et al., Macromolecules, 26, 35, 1993.

Compatibility has also been promoted in otherwise incompatible polymers by incorporating reactive groups into the polymer matrix, where such groups are capable of reacting with the photoactive monomer during the holographic recording step. Some of the photoactive monomer will thereby be grafted onto the matrix during recording. If there are enough of these grafts, it is possible to prevent or reduce phase separation during recording. However, if the refractive index of the grafted moiety and of the monomer are relatively similar, too many grafts, e.g., more than 30% of monomers grafted to the matrix, will tend to undesirably reduce refractive index contrast.

The fabrication of a high-performance recording article requires forming a matrix polymer in which a photoactive material, preferably a photoactive monomer, is dispersed either uniformly, randomly or selectively at certain locations. Typically, fabrication of an optically flat medium involves depositing the matrix precursor/photoimageable system mixture between two plates using, for example, a gasket to contain the mixture. The plates are typically glass, but it is also possible to use other materials transparent to the radiation used to write data, e.g., a plastic such as polycarbonate or poly(methyl methacrylate). It is possible to use spacers between the plates to maintain a desired thickness for the recording medium. During the matrix cure, it is possible for shrinkage in the material to create stress in the plates, such stress altering the parallelism and/or spacing of the plates and thereby detrimentally affecting the medium's optical properties. To reduce such effects, it is useful to place the plates in an apparatus containing mounts, e.g., vacuum chucks, capable of being adjusted in response to changes in parallelism and/or spacing. In such an apparatus, it is possible to monitor the parallelism in real-time by use of a conventional interferometric method, and make any necessary adjustments during the cure. Such a method is discussed, for example, in U.S. patent application Ser. No. 08/867,563, U.S. Pat. No. 5,932,045 the disclosure of which are hereby incorporated by reference. The photorecording material of the invention is also capable of being supported in other ways. For instance, it is conceivable to dispose the matrix precursor/photoimageable system mixture into the pores of a substrate, e.g., a nanoporous glass material such as Vycor, prior to matrix cure. More conventional polymer processing is also envisioned, e.g., closed mold formation or sheet extrusion. A stratified medium is also contemplated, i.e., a medium containing multiple substrates, e.g., glass, with layers of photorecording material disposed between the substrates.

The medium of the invention is then capable of being used in a holographic system such as discussed previously. The amount of information capable of being stored in a holographic medium is proportional to the product of: the refractive index contrast, Δn, of the photorecording material, and the thickness, d, of the photorecording material. The refractive index contrast, Δn, is conventionally known, and is defined as the amplitude of the sinusoidal variations in the refractive index of a material in which a plane-wave, volume hologram has been written. The refractive index varies as: n(x)=n₀+Δn cos(Kₓ), where n(x) is the spatially varying refractive index, x is the position vector, K is the grating wavevector, and no is the baseline refractive index of the medium. See, e.g., P. Hariharan, Optical Holography: Principles, Techniques, and Applications, Cambridge University Press, Cambridge, 1991, at 44. The Δn of a material is typically calculated from the diffraction efficiency or efficiencies of a single volume hologram or a multiplexed set of volume holograms recorded in a medium. The Δ n is associated with a medium before writing, but is observed by measurement performed after recording.

Examples of other optical articles include beam filters, beam steerers or deflectors, and optical couplers. (See, e.g., L. Solymar and D. Cooke, Volume Holography and Volume Gratings, Academic Press, 315-327 (1981), the disclosure of which is hereby incorporated by reference.) A beam filter separates part of an incident laser beam that is traveling along a particular angle from the rest of the beam. Specifically, the Bragg selectivity of a thick transmission hologram is able to selectively diffract light along a particular angle of incidence, while light along other angles travel undeflected through the hologram. (See, e.g., J. E. Ludman et al., “Very thick holographic nonspatial filtering of laser beams,” Optical Engineering, Vol. 36, No. 6, 1700 (1997), the disclosure of which is hereby incorporated by reference.) A beam steerer is a hologram that deflects light incident at the Bragg angle. An optical coupler is typically a combination of beam deflectors that steer light from a source to a target. These articles, typically referred to as holographic optical elements, are fabricated by imaging a particular optical interference pattern within a recording medium, as discussed previously with respect to data storage. Medium for these holographic optical elements are capable of being formed by the techniques discussed herein for recording media or waveguides.

As mentioned previously, the material principles discussed herein are applicable not only to hologram formation, but also to formation of optical transmission devices such as waveguides. Polymeric optical waveguides are discussed for example in B. L. Booth, “Optical Interconnection Polymers,” in Polymers for Lightwave and Integrated Optics, Technology and Applications, L. A. Hornak, ed., Marcel Dekker, Inc. (1992); U.S. Pat. No. 5,292,620; and U.S. Pat. No. 5,219,710, the disclosures of which are hereby incorporated by reference. Essentially, the recording material of the invention is irradiated in a desired waveguide pattern to provide refractive index contrast between the waveguide pattern and the surrounding (cladding) material. It is possible for exposure to be performed, for example, by a focused laser light or by use of a mask with a non-focused light source. Generally, a single layer is exposed in this manner to provide the waveguide pattern, and additional layers are added to complete the cladding, thereby completing the waveguide. The process is discussed for example at pages 235-36 of Booth, supra, and cols. 5 and 6 of U.S. Pat. No. 5,292,620. A benefit of the invention is that by using conventional molding techniques, it is possible to mold the matrix/photoimageable system mixture into a variety of shapes prior to matrix cure. For example, the matrix/photoimageable system mixture is able to be molded into ridge waveguides, wherein refractive index patterns are then written into the molded structures. It is thereby possible to easily form structures such as Bragg gratings. This feature of the invention increases the breadth of applications in which such polymeric waveguides would be useful.

High performance holographic recording articles are characterized by low shrinkage, dynamic range, and sensitivity. Low shrinkage will assure non-degradation of the recorded holograms and total fidelity of the holographic data to be recovered. Low shrinkage in the range of less than 0.2% is required. The dynamic range of a holographic recording medium is typically characterized by the parameter, M/#, a measure of how many holograms of a given average diffraction efficiency can be stored in a common volume. The M/# is determined by both the refractive index contrast and thickness of a medium. Typical values of M/# are 1.5 or better for 200 μm thickness.

The photosensitivity is characterized by the total exposure time required to consume the dynamic range of the media. The sensitivity is measured by the cumulative exposure time required to reach 80% of the total M/# of the recording medium. The higher the sensitivity of the material, the shorter the cumulative exposure time required to reach 80% of the total M/#. The sensitivity can be in the range of 5 to 600 seconds. The higher the sensitivity of the material, the shorter the exposure time required to the dynamic range of the media.

Details of the measurements of the recording-induced shrinkage, M/# for a 200 μm thick media, and sensitivity are described in detail in Applied Physics Letters, Volume 73, Number 10, p. 1337-1339, 7 September 1998, which is incorporated herein by reference. Angle-multiplexing a series of plane-wave holograms into the recording medium produces these measurements. The laser used for recording and recovery of the multiplexed holograms was spatially filtered and collimated by a lens to yield a plane-wave source of light. The light was then split into two beams by polarizing beam splitters and half-wave plates and intersected at the sample at an external angle of 44°. The power of each beam was 2 mW and the spot diameter was 4 mm. Each hologram is written with a predetermined exposure time. After recording, the material was allowed to sit in the dark for 10 minutes and then flood cured with a Xenon lamp filtered to transmit wavelengths longer than 420 nm.

The invention will be further clarified by the following examples, which are intended to be exemplary.

### EXAMPLES

To fabricate the high-performance recording article, a NCO-terminated prepolymer and a polyol must first be reacted to form a matrix in which the acrylate monomer, which remains unreacted, will reside.

As the reaction of the NCO-terminated prepolymer and polyol are a two-component system, the NCO-terminated prepolymer, acrylate monomer, photoinitiator, and thermal stabilizers are predissolved to form a homogeneous solution before charging into one of the holding tanks of a Posiratio two-component metering, mixing and dispensing machine, available from Liquid Control Corp. The polyol, tin catalyst, and other additives are premixed and charged into another holding tank. Each tank is then degassed, adjusting dispensing of materials from the tanks to the desired amount according to the procedures outlined by Liquid Control. Precise and accurate mixing of the two components, free of entrapped air bubbles, is carried out by metering the liquid from both tanks simultaneously into a helical element static mixer.

To form a holographic recording article, the desired amount of the well-mixed solution is dispensed onto the inner surface of the bottom substrate held by one of the parallel plates. The upper substrate, which is held by the other parallel plate, is then brought down to come in contact with the solution and held at a predetermined distance from the bottom plate, according to the procedures described in U.S. Pat. No. 5,932,045 issued Aug. 3, 1999, the disclosure of which is hereby incorporated by reference. The entire set-up is held till the mixing becomes solidified to assure an optically flat article is produced.

For less soluble photoinitiators, however, mixing the isocyanate and initiator with a solvent and then stripping the solvent under vacuum can be implemented to facilitate dissolution. Alternatively, the photoinitiator/isocyanate mix can be heated provided that no other components of the formulations are heat sensitive.

A dispensing apparatus and the optical flats could also be used for making quality articles for recording digital data, but it is not necessary for plane wave data as is described in examples below. The inventors merely applied the formula between glass slides and used spacers to adjust thickness.

### Example 1

A working system consists of a small concentration of Methylene Blue (or other dye which absorbs at longer wavelengths than the write laser and write monomer initiating system) of equivalent or slightly greater concentration than inhibiting species in the sample in combination with 0.5 wt. % borate salt dissolved in the matrix/write monomer/write photoinitiator system. A red diode or other red, non-coherent light source (when using Methylene Blue) is used to pre-expose the sample for a pre-determined time sufficient to bleach all of the absorbing dye. This pre-exposure step generates radicals sufficient to react with an approximately equivalent number of inhibiting species. Once all of the absorbing dye is consumed in the photoreaction, no further radicals can be produced with the long wavelength light source. The writing process using a shorter wavelength laser occurs with very little to no inhibition.

Additionally, such a system could potentially be used as both a protective measure and as an internal check for determining when writing can commence. As a protective measure, the long wavelength absorbing dye is chosen such that it also strongly absorbs at the laser wavelength used for writing. If accidental exposure of light capable of initiating the write monomer system occurs, the long wavelength absorbing dye would be first to react, preventing loss of monomer until the dye is consumed. This is true because some dyes are themselves inhibitors. Thus, the dye behaves as a buffer preventing accidental initiation of the write monomer. As an internal check for determining when writing can proceed, a light sensor can be used to monitor the photo bleaching of the long wavelength absorbing dye. Upon reaching approximately 100% transmittance (taking into account reflections and scattering), the sample would be ready for the write process. Such an internal method for determining when a sample has been properly pre-exposed allows for a more efficient system (both of time and energy).

### Example 2

A method for determining when the inhibitors have been consumed would use an indicator molecule (or system) capable of providing inhibitor concentration information in real time. An example of such an indicator is pyrene or certain ruthenium complexes whose fluorescence is quenched by oxygen (which typically represents the largest proportion of inhibitor). The laser used for writing (or any light source which the photoinitiator used for recording absorbs) is used for illuminating the area as a pre-exposure until fluorescence is observed from the indicator molecule. This implies that the indicator is capable of absorbing the same wavelengths as the light used to illuminate the pre-exposure area. Fluorescence intensity from the indicator is in direct proportion to the concentration of oxygen in the system. When fluorescence is maximized, the concentration of oxygen is low and recording without inhibition proceeds.

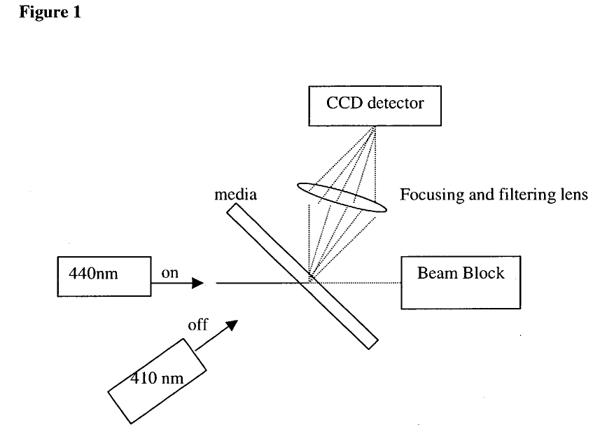

Using a blue 410 nm laser diode for writing and a 440 nm diode for indicator stimulation, the following setup shown in FIG. 1 was used. For simplicity, the mirror and lens system used to record the hologram have been omitted. The focusing and filtering lens is a focusing lens in addition to a cut off filter, preventing light of lower than 455 nm from passing. This insures that only fluorescent or phosphorescent light reaches the charged couple device (CCD) detector. This lens is not in place for recording and read out of hologram. The CCD detector measures the intensity of the light. In such a manner, the indicator can be measured in real time. For instance, an initial fluorescence intensity is determined (while 440 nm diode is on) and then the 410 nm laser is switched on, in real time the fluorescence intensity of the indicator molecule is measured (it will rise to a limiting value). In real time, an onboard processor determines the asymptotic value, and switches the 410 nm laser off when 95% of the asymptotic value is reached. At this point the filter lens is removed and the recording can begin with negligible inhibition. In the above embodiment, the indicator absorbed at a lower wavelength than the initiator and thus a different light source was used to excite the fluoromore. However, some initiators have a fluorescence or phosphorescence of their own (e.g., benzophenone) and thus the recording wavelength alone can be used in conjunction with the filtering lens. This latter embodiment also covers the case for Example 3.

The advantage of indicator system is that it potentially does not require a separate light source nor added dye components. However, the indicator system may use a separate light source for stimulating fluorescence from the indicator.

### Example 3

Using a blue 410 nm laser diode for writing and a 440 nm diode for indicator stimulation, the setup shown in FIG. 1 was used as in Example 2. A technique using the write laser involves the use of a fluorescence probe dye as an indicator of oxygen. Several dyes such as pyrene (excimer fluorescence) or some ruthenium complexes are known to exhibit oxygen quenching of fluorescence and are used as sensors for dissolved oxygen. Under such use, the dye would be excited by longer wavelength light while a light detector measures the amount of fluorescent light generated. A short pre-exposure with the write laser occurs and then another fluorescence measurement is taken. This pre-exposure-fluorescence measurement routine continues until fluorescence is maximized, and then the write process begins.

### Example 4

This example demonstrates the dual nature of the dye/dye system as an inhibitor/protector and as an inhibitor scavenger.

On a photo-DSC using laminate conditions (the laminate did not absorb at either wavelength of light used), measurements of both exotherm and inhibition time were made. Four solutions were made and evaluated. The blue light source was a 440 nm 2-diode with a 5 mW/cm intensity at the sample. The red light source was a 635 nm diode with a 5 mW/cm intensity at the sample.

Sample 1: Consisted of 2-hydroxyethyl acrylate (99 wt %) and Irgacure 784 (0.6 wt %).

Sample 2: Consisted of 2-hydroxyethyl acrylate (97 wt %), allyl thiourea (2.3 wt %), and Irgacure 784 (0.4 wt %).

Sample 3: Consisted of 2-hydroxyethyl acrylate (97 wt %)allyl thiourea (2.3 wt %), Irgacure 784 (0.4 wt %), and thionin derivative (0.05 wt %).

Sample 4: Consisted of 2-hydroxyethyl acrylate (97 wt %), allyl thiourea (2.3 wt %), Irgacure 784 (0.4 wt %), and thionin derivative (0.05 wt %).

Results and explanations: Blue light exposure of Sample 1 gave an inhibition time of 0.85 seconds. Blue light exposure of Sample 2 gave an inhibition time of 0.85 seconds. The first two samples function as controls to which to compare the effect of the dye in Samples 3 and 4. Blue light exposure of Sample 3 gave an inhibition time of 1.93 seconds. This demonstrates that addition of the dye protects the media even though in this case, the dye does not absorb appreciably at 440 nm. Thus confirming the dye's inhibitory/buffer behavior. Red light exposure (20 seconds) of Sample 4 gave no exotherm. However, the red absorbing dye was visibly bleached and only the yellow color of Irgacure 785 remained. Subsequent irradiation with the blue light source gave an inhibition time of 0.0 seconds. This demonstrates that the concentration of the thionin derivative is sufficiently low to prevent cure when it is independently irradiated and yet high enough to eliminate most if not all of the inhibitory agents.

One major advantage of fluorescence quenching is that multiple exposures with multiple time-separated pre-exposures are possible, thus a sample can be written many times over the course of weeks or months with each write process properly pre-exposed. Additionally, only trace amounts of fluoromore (fluorescence chromophore) are needed and thus do not represent a significant portion of the matrix formulation.

The advantage of this pre-exposure method is that over-exposure is prevented and the ability to generate a specific number of radicals during the pre-exposure enhances reproducibility under normal writing conditions.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. Persons skilled in the art would recognize that the numerical ranges disclosed inherently support any range within the disclosed numerical ranges even though a precise range limitation is not stated verbatim in the specification because this invention can be practiced throughout the disclosed numerical ranges. A holding to the contrary would “let form triumph over substance” and allow the written description requirement to eviscerate claims that might be narrowed during prosecution simply because the applicants broadly disclose in this application but then might narrow their claims during prosecution. Finally, the entire disclosure of the priority documents, patents and publications referred in this application are hereby incorporated herein by reference.

1. An optical article comprising a photoactive material that records a hologram upon exposure of the photoactive material to a first wavelength of light, a reaction inhibitor that inhibits a reaction of said photoactive material and a photoactive ingredient that reacts with said reaction inhibitor upon exposure of said photoactive ingredient to a second wavelength of light, wherein the second wavelength is different from the first wavelength and the photoactive material records no hologram at the second wavelength.

2. The optical article of claim 1, further comprising a photoinitiator that initiates the reaction of the photoactive material.

3. The optical article of claim 1, further comprising oxygen and a material that upon excitation with light either directly or indirectly eliminates free oxygen from the system before recording.

4. The optical article of claim 1, wherein the photoactive ingredient is selected from the group consisting of a photoactive dye, a reducing or oxidizing agent, an indicator molecule or monomer, and combinations thereof.

5. The optical article of claim 1, wherein the photoactive ingredient produces a reactive species that reacts with the reaction inhibitor.

6. The optical article of claim 1, wherein the photoactive material comprises a monomer component selected from a group consisting of an acrylate, vinyl ether, styrene derivative, vinyl amide, vinyl ester, epoxide, thiol-ene system, or combination thereof.

7. The optical article of claim 1, wherein the optical article is a holographic recording medium.

8. The optical article of claim 1, wherein a component of the photoactive ingredient is selected from the group consisting of an acetophenone derivative, an aromatic ketone derivative, a photoreducible dye, rose bengal, fluorescein, methylene blue and derivatives, thionin and derivatives, coumarins, camphorquinones, inorganic complexes, phosphine oxide derivatives, thione derivatives and combinations thereof.

9. The optical article of claim 8, further comprising a component selected from the group consisting of an amine, a borate salt, a fluorescent component, a thiourea derivative, a thioacetamide derivative, a stannate derivative, a tertiary phosphine, a sulfinic acid or salt, a thiophosphite, a diazo sulphate salt, a peroxide, a disulfide, an ascorbic acid derivative, a tin(II) derivative, and combinations thereof.

10. The optical article of claim 1, wherein the photoactive material is dispersed in or located on a polymer selected from a group consisting of a polyurethane, an epoxy, a polyamide, a polyester, a polyether, a poly (vinyl ether), a poly (vinyl acrylate) and derivatives, a poly (vinyl halogen), a thiol-ene system, a gelatin, a polyamine, a polysilane, a silicone, a silicate, a poly (maleic anhydride) derivative, and combinations thereof.

11. The optical article of claim 1, wherein the second wavelength is greater or lesser than the first wavelength.

12. The optical article of claim 1, further comprising a cobalt-containing compound.

13. The optical article of claim 1, wherein the photoactive ingredient is dispersed in or located on the polymer matrix.

14. The optical article of claim 1, wherein the photoactive ingredient is not within the polymer matrix but instead located as a layer on or with in the article.

15. A method for protecting an optical article comprising a photoactive material that records a hologram upon exposure of the photoactive material to a first wavelength of light, a reaction inhibitor that inhibits a reaction of said photoactive material and a photoactive ingredient that reacts with said reaction inhibitor upon exposure of said photoactive ingredient to a second wavelength of light, wherein the second wavelength is different from the first wavelength and the photoactive material records no hologram at the second wavelength, said method comprising exposing the optical article to the second wavelength of light and bleaching said reaction inhibitor and substantially removing said reaction inhibitor.

16. The method of claim 15, the optical article further comprising a photoinitiator that initiates the reaction of the photoactive material.

17. The method of claim 15, the optical article further comprising oxygen and a material that reacts or binds with oxygen upon irradiation with light.

18. The method of claim 15, wherein the photoactive ingredient is a photoactive dye.

19. The method of claim 15, wherein the photoactive ingredient produces a reactive species that reacts with the reaction inhibitor.

20. The method of claim 15, wherein the photoactive material is an acrylate, a vinyl ether, a styrene derivative, a vinyl amide, a vinyl ester, a epoxide, a thiol-ene system, or a combination thereof.

21. The method of claim 15, wherein the optical article is a holographic recording medium.

22. The method of claim 15, further comprising determining a concentration of the reaction inhibitor in real time.

23. The method of claim 15, wherein the optical article further comprises a fluorescent component whose fluorescence or phosphorescence is quenched by oxygen or changed upon polymerization.

24. The method of claim 23, wherein the fluorescent component measures a concentration of the reaction inhibitor and/or a dynamic range of the optical article.

25. A method for manufacturing an optical article comprising dispersing a photoactive material and a reaction inhibitor in a polymer and forming the optical article, wherein the photoactive material records a hologram upon exposure of the photoactive material to a first wavelength of light, the reaction inhibitor inhibits a reaction of said photoactive material and the optical article comprises a photoactive ingredient that reacts with said reaction inhibitor upon exposure of said photoactive ingredient to a second wavelength of light, and further wherein the second wavelength is different from the first wavelength and the photoactive material records no hologram at the second wavelength.

26. The method of claim 25, the optical article further comprising a photoinitiator that initiates the reaction of the photoactive material.

27. The method of claim 25, the optical article further comprising oxygen and a material reacts or binds with oxygen upon irradiation with light.

28. The method of claim 25, wherein the photoactive ingredient is a photoactive dye.

29. The method of claim 25, wherein the photoactive ingredient produces a reactive species that reacts with the reaction inhibitor.

30. The method of claim 25, wherein the photoactive material is an acrylate, a vinyl ether, a styrene derivative, a vinyl amide, a vinyl ester, a epoxide, a thiol-ene system, or a combination thereof.

32. The method of claim 25, wherein the optical article is a holographic recording medium.

33. The method of claim 25, wherein the photoactive material is dispersed in or located on a polymer selected from a group consisting of a polyurethane, an epoxy, an polyamide, a polyester and combinations thereof.

34. The method of claim 25, wherein the photoactive ingredient is dispersed in the polymer.

35. The method of claim 25, wherein the photoactive ingredient is not within the polymer but instead in a layer on the polymer.

36. The optical article of claim 1, further comprising a metal ion-containing compound of barium, strontium, iron, cobalt, nickel, copper, tin, or bismuth.

37. The optical article of claim 4, wherein the photoactive dye does not need a donor.

38. The optical article of claim 1, wherein the photoactive ingredient need not be photoactive but is instead active at room temperature or upon heating.
